(19) United States
(12) Patent Application Publication
(10) Pub. No.: US 2010/0060198 A1
(43) Pub. Date: Mar. 11, 2010

(54) LED Lamp and Method for Producing a LED Lamp

(75) Inventor: Tony van Endert, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/205,375

(22) Filed: Sep. 5, 2008

(51) Int. Cl. H05B 37/02; H01J 9/00

(52) U.S. Cl. 315/297; 445/1

(57) ABSTRACT

A lamp provided with at least two LEDs of substantially the same colour and at least one driver for feeding each of said LEDs, wherein said at least one driver is adapted to feed said at least two LEDs during operation of the lamp at a different power level such that the largest difference in colour temperature of any pair of said LEDs during operation is less than the largest difference in colour temperature of any pair of said LEDs if being fed at an equal operational power level.

### FIELD OF THE INVENTION

The invention relates to a lamp provided with at least two LEDs of substantially the same colour and at least one driver for feeding each of said LEDs. In particular the invention relates to a lamp wherein said LEDs are white light emitting LEDs, for instance blue light emitting diodes provided with red, green and/or yellow emitting phosphors, such as white light emitting InGaN LEDs. The invention furthermore relates to a method for producing a lamp.

### BACKGROUND OF THE INVENTION

Colour temperature is the physical temperature of a heated Planckian radiator. The colour temperature of phosphor LEDs can vary due to small difference in the amounts of phosphor applied to the LED. The consistency of colour temperature of the source is important for uniformity of appearance, especially in white light LED luminaries. When designing a lighting system, colour binning is therefore an important consideration. Colour binning is the process of grouping (white) LED's based on their various characteristics and assigning them a specific bin code. LED's with the same characteristics are placed on a reel. An example of white colour binning within a CIE chromaticity diagram is given in FIG. 1, wherein each box indicates a bin. It has been shown that CCT variations of a white LED in a single bin can exceed 500 K, which is clearly noticeable by a human observer, who is normally capable of distinguishing CCT differences of 50 to 100 K in the range from 2000 K to 6000 K, which is the range of CCT variations of daylight. Above 6000 K CCT differences perceived by human eye will be around 200 K. When designing a lighting system with at least two or more white LEDs colour differences can occur due to CCT variations between the white LED's, even within a single bin.

It is an objective of the invention to provide a LED luminary with a uniform colour temperature. The objective of the proposed idea is to provide a white luminary with adjustable correlated colour temperature (CCT) to avoid visible colour effects between the white LED's.

### SUMMARY OF THE INVENTION

According to the invention, preferably said at least one driver is adapted to feed said at least two LEDs during operation of the lamp at a different power level such that the largest difference in colour temperature of any pair of said LEDs during operation is less than the largest difference in colour temperature of any pair of said LEDs if being fed at an equal operational power level.

The lamp is preferably provided with means for measuring the temperature of the lamp or a correlated quantity thereof, and processing means arranged to adapt said power levels of said at least two LEDs in dependence of said measurement. Said processing means is preferably arranged to adapt said power level such that a predetermined junction temperature or a correlated quantity thereof is achieved. Said means for measuring the temperature of the lamp are preferably arranged to measure the temperature of each of said at least two LEDs separately, or a correlated quantity thereof, said at least two LEDs are preferably thermally insulated from each other, and each of said at least two LEDs are preferably provided with a separate heat sink. Said means for measuring the temperature are preferably arranged to measure the temperature of the junction of said LEDs or a correlated quantity thereof, such as described in WO 2006/043232. With this temperature information light output will be controlled such that CCT value of each LED will be the same or nearly the same. The control of the individual LEDs is such, that the total light output (in lumen) of the luminaries system will stay constant, or alternatively at a desired dimming level.

According to the preferred method for producing the lamp the colour temperature at a predetermined power level of each of said LEDs is measured, and the driver is adapted in dependence of said measured colour temperature to feed each LED of said lamp during operation of the lamp at a power level, such that the largest difference in colour temperature of any pair of said LEDs during operation is less than the largest difference in colour temperature of any pair of said LEDs if said LEDs are fed at an equal operational power level.

### BRIEF DESCRIPTION OF THE DRAWINGS

The invention will be further explained by means of a preferred embodiment as shown in the accompanying drawings, wherein:

FIG. 1 is an example of a binning scheme in a CIE chromaticity diagram;

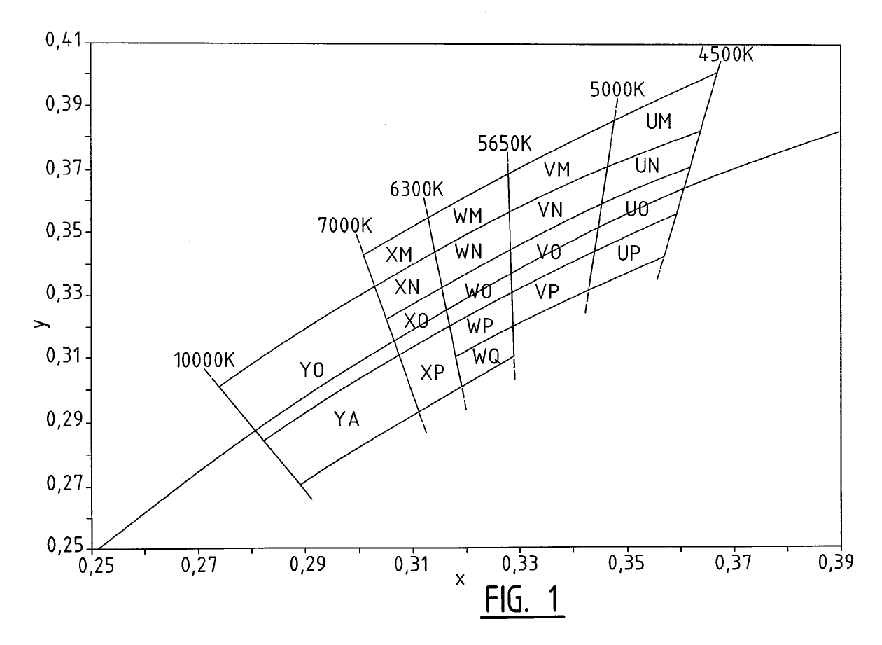

FIG. 2 is a schematic view of a luminary;

FIG. 3 is a diagram of colour temperature against junction temperature, showing the principle of the invention;

FIG. 4 is a diagram of normalized luminous flux against temperature;

FIG. 5 is a flow chart of initial colour temperature measurement of the LEDs and the establishment of target values for the junction temperatures of the LEDs;

FIG. 6A and 6B is a flow chart of a colour temperature control algorithm; and

FIG. 7 is a diagram of colour temperature against junction temperature, showing a second example of the principle of the invention.

### DETAILED DESCRIPTION OF THE PREFERRED EMBODIMENT

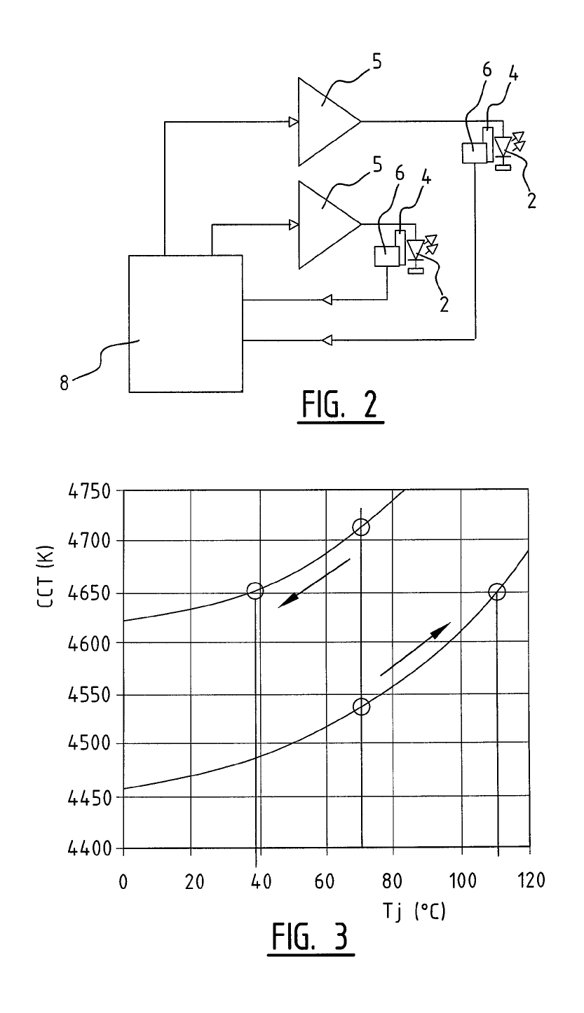

A LED luminary comprising at least two LED sources is shown in FIG. 2. The luminary includes a plurality of at least two LED sources 2 provided with phosphors and emitting substantially the same colour, such as white InGaN LEDs. Due to small differences in phosphor quantities on the LEDs, at an equal luminous flux level the CCT values of both white LEDs are different, but are still inside the same white colour binning range. The invention reduces or eliminates these differences in colour temperature between the LEDs by adapting the power sent through the individual LEDs in the luminary.

Each LED source 2 is provided with a separate heat-sink 4, and are thermally insulated from each other LED drivers 5 are configured to provide regulated power to the respective LED light sources 2, wherein the power level of the individual LEDs is controlled by a controller 8.

The luminary further includes temperature sensors 6. Temperature sensors 6 are configured to obtain the junction temperature of the LEDs. Temperature sensors 6 may include a thermistor, or a thermopile, or any silicon based sensor (for instance a NTC resistor). Alternatively one temperature sensor may be employed to measure the case temperature of the LED luminary. The junction temperature of each individual LED may then be estimated by employing a thermal model of the LED light sources and the electrical current input to the LEDs, but also the single measured temperature of the case may be used as a representative of the junction temperature of the individual LEDs. The junction temperature of the LEDs is measured or estimated so as to determine the required power of the LEDs that provide the desired color temperature. Another alternative to estimate the junction temperature is to use the forward voltage drop across the LED, as described in U.S. Pat. No. 7,052,180, as the forward voltage drop across a LED varies approximately linearly with the temperature.

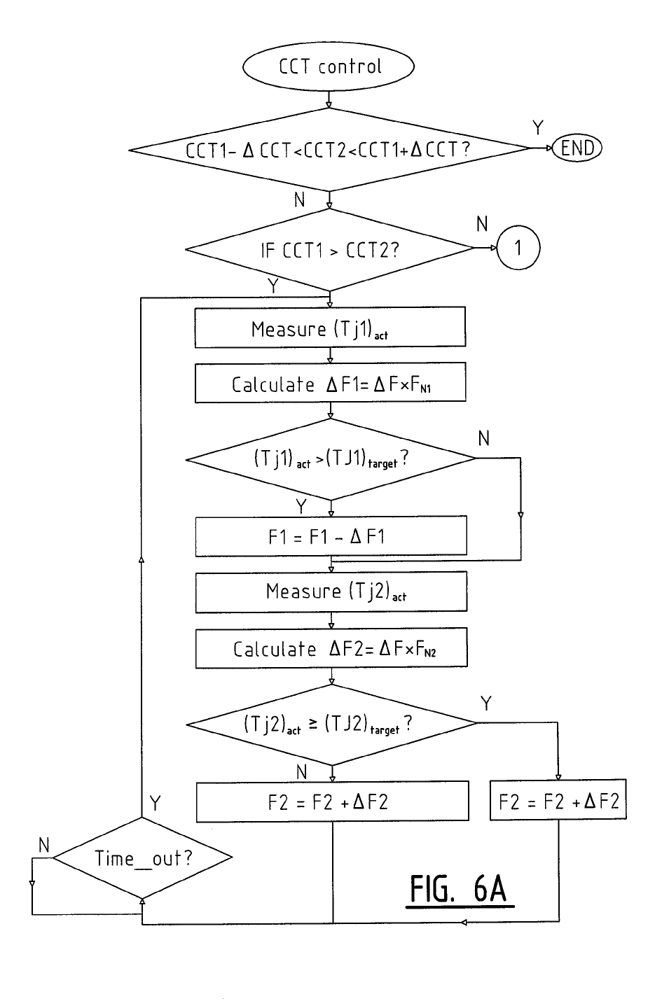

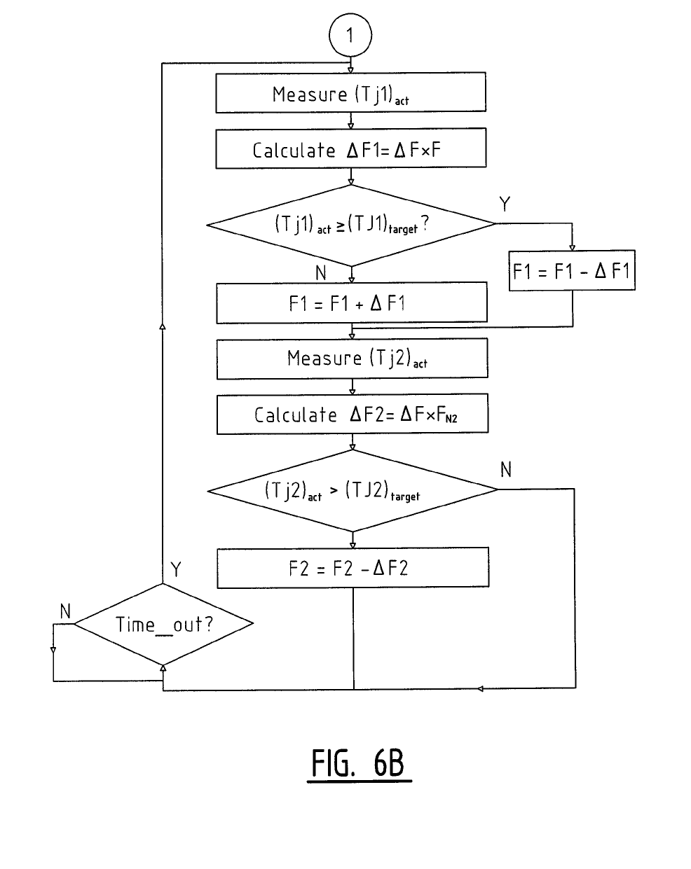

Controller 8 is provided with a microcontroller, digital memory and digital signal processors. As shown in the flow chart of FIG. 5, the memory stores target junction temperature data (Tj1_{target} and Tj2_{target}) that have been previously calculated based on test data (Tj1 and Tj2, CCT1 and CCT2, F1 and F2) of the individual LEDs at a initial equal current (If1ₐᵥ and If2ₐᵥ). The junction temperature data of the LED light sources are computed off-line as a function of the total required luminous flux of the luminary, which may be set through user input (dimming). The microcontroller is configured to receive LED junction temperature data from temperature sensors 6 compare these data with the stored target temperature data. The microcontroller then controls the power level of the individual LED drivers 5 based on said required power output data, as shown in FIGS. 6A and 6B, and as explained in more detail below.

The CCT value of the white LEDs is changed by changing the junction temperature Tj of the LED. With an increase in junction temperature, the white LED CCT shifts to a higher value, as shown in FIG. 2. This function can be described as CCT=a*(Tj)²+b*Tj+c.

By changing the power through the LED, the light output (luminous flux F) as well as the junction temperature Tj will change. The light output is changed by a Pulse Width Modulation based control function with constant forward current Ifmax. Ifmax is equal for all LEDs and is independent from the LED junction temperature Tj. A change of the duty cycle of the PWM signal will change Ifav. The power dissipation in the LED can be described as P=Ifₐᵥ*Vf, wherein Vf is the forward voltage and is temperature dependent (Tj=Ta+P*Rⱼ₋ₐ). If the power is increased the junction temperature will also increase.

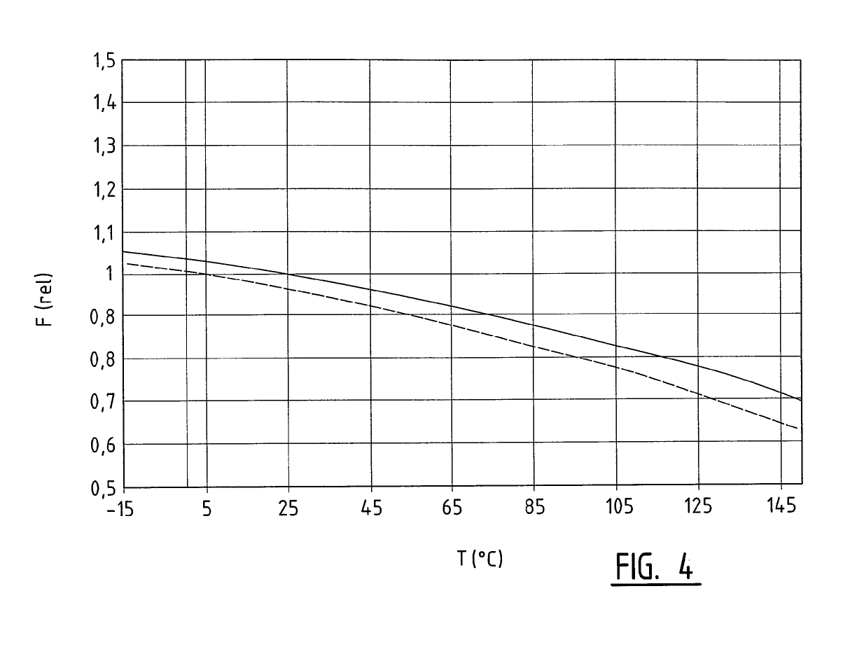

The total luminous flux of the system, which is the summation of the luminous flux of each white LED light source in the system, is kept constant, or alteratively, in a luminary which can be dimmed, the total luminous flux will be kept at the desired value. In order to reduce the CCT difference between both LEDs while at the same time maintaining a constant total luminux flux of the luminary, the relevant parameters are changed in opposite directions. This means that the junction temperature of one LED is increased by increasing of the luminous flux of that LED. For the other LED the junction temperature is decreased by decreasing the luminous flux of that LED, as shown in the example of FIG. 3.

For this example, the initial CCT values at a certain junction temperature as measured in the factory for both white LEDs are stored in memory:
LED1: CCT1=4720 K at Tj1=70° C.; Luminous flux F1=F
LED2: CCT2=4540 K at Tj2=70° C.; Luminous flux F2=F

The total luminous flux is F1+F2=2F.

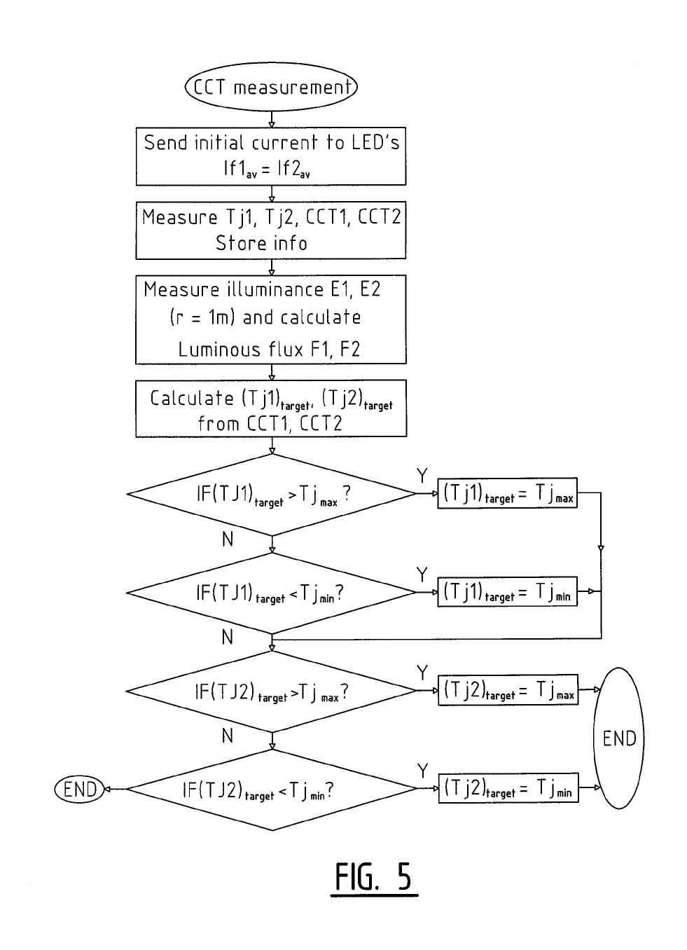

However, the CCT1 and CCT2 values of both white LEDs have to be more or less equal in order to avoid visible colour errors. This is achieved by changing the individual power levels of LED1 and LED2. At the same time, the two different power levels through LED1 and LED2 have to be chosen such, that the total luminous flux of the luminaries remains constant (F1+F2=2F). As shown in FIG. 4, the luminous flux is further dependent on the junction temperature (upper line) or the heat sink or case temperature (lower line) as F=a3*(Tj)²+b3*Tj+c3, so that this also has to be taken into account when calculating the power levels.

These two constraints force the controller in accordance with the algorithm of FIGS. 6A and 6B to reduce the power through LED1 and thereby the luminous flux F1, by decreasing If1ₐᵥ (with pulse width modulation) until Tj1=38° C., whereby CCT1 is decreased to 4650 K. At the same time the power through LED2 and thereby the luminous flux F2 is increased, by increasing If2ₐᵥ (with PWM) until Tj2=110° C., whereby CCT2 is increased to the same 4650 K. As a result the CCT values for both white LEDs are equal and the total luminous flux of the luminaries remains constant.

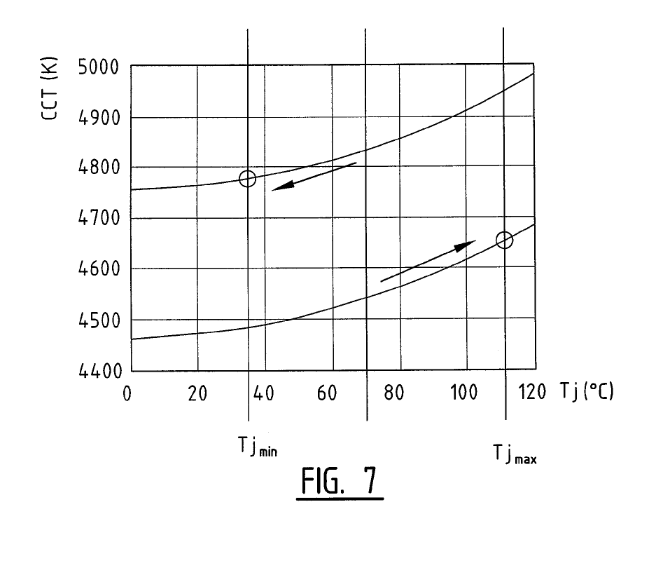

Another example is given in FIG. 7, where the maximum CCT control range is limited by a certain pre-determined minimum and maximum junction temperature. Thereby an equal CCT of both LEDs cannot be achieved, but the difference in CCT is still reduced to a level that is not visible to the human eye.

Although the invention is described herein by way of a preferred embodiment as an example, the man skilled in the art will appreciate that many modifications and variations are possible within the scope of the invention.

1. A lamp provided with at least two LEDs of substantially the same colour and at least one driver for feeding each of said LEDs, wherein said at least one driver is adapted to feed said at least two LEDs during operation of the lamp at a different power level such that the largest difference in colour temperature of any pair of said LEDs during operation is less than the largest difference in colour temperature of any pair of said LEDs if being fed at an equal operational power level.

2. The lamp of claim 1, wherein said LEDs are white light emitting LEDs.

3. The lamp of claim 2, wherein said LEDs are blue light emitting diodes provided with red, green and/or yellow emitting phosphors.

4. The lamp of claim 3, wherein said LEDs are white light emitting InGaN LEDs.

5. The lamp of claim 1, wherein the lamp is further provided with means for measuring the temperature of the lamp or a correlated quantity thereof, and processing means arranged to adapt said power levels of said at least two LEDs in dependence of said measurement.

6. The lamp of claim 5, wherein said processing means is arranged to adapt said power level such that a predetermined junction temperature or a correlated quantity thereof is achieved.

7. The lamp of claim 5, wherein said means for measuring the temperature of the lamp are arranged to measure the temperature of each of said at least two LEDs separately, or a correlated quantity thereof.

8. The lamp of claim 5, wherein said at least two LEDs are thermally insulated from each other.

9. The lamp of claim 8, wherein each of said at least two LEDs are provided with a separate heat sink.

10. The lamp of claim 5, wherein said means for measuring the temperature are arranged to measure the temperature of the junction of said LEDs or a correlated quantity thereof.

11. A method for producing a lamp, wherein the lamp is provided with at least two LEDs of substantially the same colour and at least one driver for feeding each of said LEDs, wherein the colour temperature at a predetermined power level of each of said LEDs is measured, and wherein the driver is adapted in dependence of said measured colour temperature to feed each LED of said lamp during operation of the lamp at a power level, such that the largest difference in colour temperature of any pair of said LEDs during operation is less than the largest difference in colour temperature of any pair of said LEDs if being fed at an equal operational power level.
